(19) United States
(12) Patent Application Publication
(10) Pub. No.: US 2014/0364013 A1
(43) Pub. Date: Dec. 11, 2014

(54) ELECTRICAL CONNECTOR ASSEMBLY

(71) Applicant: ALLTOP ELECTRONICS (SUZHOU) LTD., Taicang City (CN)

(72) Inventor: Wang-I YU, JHONGHE-City (TW)

(73) Assignee: ALLTOP ELECTRONICS (SUZHOU) LTD., Taicang City (CN)

(21) Appl. No.: 14/015,554

(22) Filed: Aug. 30, 2013

(30) Foreign Application Priority Data
Jun. 8, 2013 (CN) 201310227999.9

(51) Int. Cl. H01R 24/60

(52) U.S. Cl. CPC H01R 24/60
USPC 439/660

(57) ABSTRACT

A receptacle connector adapted for mating with a plug connector, includes a receptacle housing defining a receiving space, a number of receptacle contacts received in the receptacle housing and partially exposed into the receiving space, and a receptacle shell including a top wall, a bottom wall and a pair of sidewalls connecting with the top wall and the bottom wall. Each sidewall defines an opening and forms a trapezoidal-shape elastic arm extending rearward from one edge of the opening and curved toward the receiving space. The bottom wall forms at least one protruding rib protruding toward the top wall and extending along a mating direction between the plug connector and the receptacle connector for assuring the contact journal between the plug connector and the receptacle connector.

### BACKGROUND OF THE INVENTION

1. Field of the Invention

The present invention relates to an electrical connector assembly, more particularly to an electrical connector assembly mounted on a Printed Circuit Board (PCB).

2. Description of Related Art

With the rapid development of the electronic technology, USB connectors are widely used in electronic products for exchanging information and data etc. with external equipments. A USB connector usually comprises an insulative housing, a plurality of contacts accommodated in the insulative housing, and an outer shell enclosing the insulative housing and the contacts. Conventional USB plug connector usually has an outer shell which does not enclose a mating portion of the plug connector mating with a USB receptacle connector.

To satisfy the requirements of stable signal transmission and high transmission efficiency of the electronic products, USB plug connector and receptacle connector need to mate with each other stably. However, a triangle-shape elastic arm is usually arranged on each sidewall of the USB receptacle connector which is prone to causing mating failure between the plug connector and the receptacle connector since the mating portion is easy to be interfered by the triangle-shape elastic arm.

Hence, it is necessary to improve the conventional USB connector to address problems mentioned above.

### BRIEF SUMMARY OF THE INVENTION

Accordingly, an object of the present invention is to provide an electrical connector assembly which could realize quick and reliable connection.

In order to achieve the above-mentioned object, an electrical connector assembly in accordance with the present invention, comprises a plug connector and a receptacle connector mating with the plug connector. The plug connector comprises a plug housing comprising at least an insertion section extending from the plug housing, a plug shell partially enclosing the plug housing with the insertion section not enclosed, and a plurality of plug contacts accommodated in the plug housing. The receptacle connector comprises a plurality of receptacle contacts electrically connecting with the plug contacts to form an electrical connection between the plug connector and the receptacle connector, a receptacle housing accommodating the receptacle contacts, and a receptacle shell comprising a top wall, a bottom wall and a pair of sidewalls connecting with the top wall and the bottom wall. Each sidewall defines an opening and forms a trapezoidal-shape elastic arm extending rearward from one edge of the opening and curved toward the receiving space.

The bottom wall forms at least one protruding rib protruding toward the top wall and extending along a mating direction between the plug connector and the receptacle connector for assuring the contact journal between the plug connector and the receptacle connector. The receptacle housing defines a receiving space to receive the insertion section of the plug connector to form the electrical connection between the plug contacts and the receptacle contacts in the receiving space.

The foregoing has outlined rather broadly the features and technical advantages of the present invention in order that the detailed description of the invention that follows may be better understood. Additional features and advantages of the invention will be described hereinafter, which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of an electrical connector assembly in accordance with the present invention;

FIG. 2 is a perspective view of a plug connector shown in FIG. 1;

FIG. 3 is a perspective view of a receptacle connector shown in FIG. 1;

FIG. 4 is an exploded, perspective view of the receptacle connector shown in FIG. 3;

FIG. 5 is a perspective view of a receptacle housing shown in

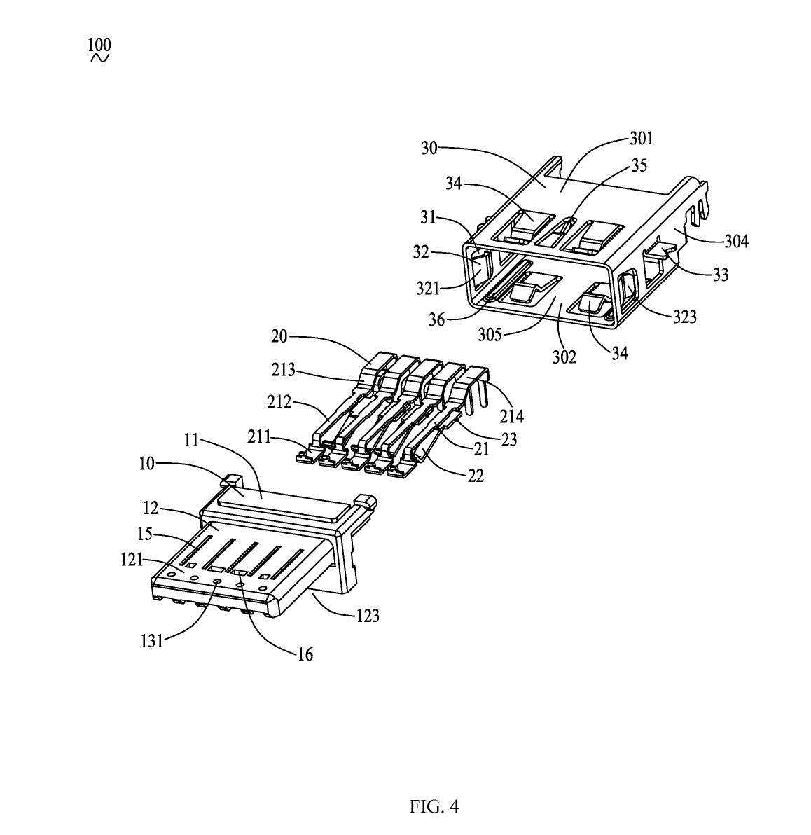

FIG. 4;

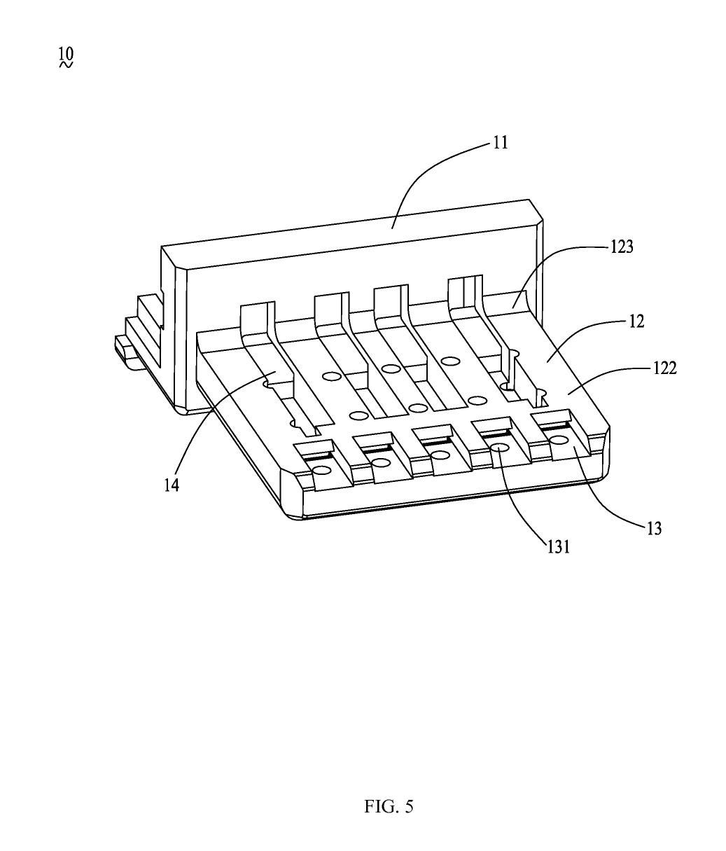

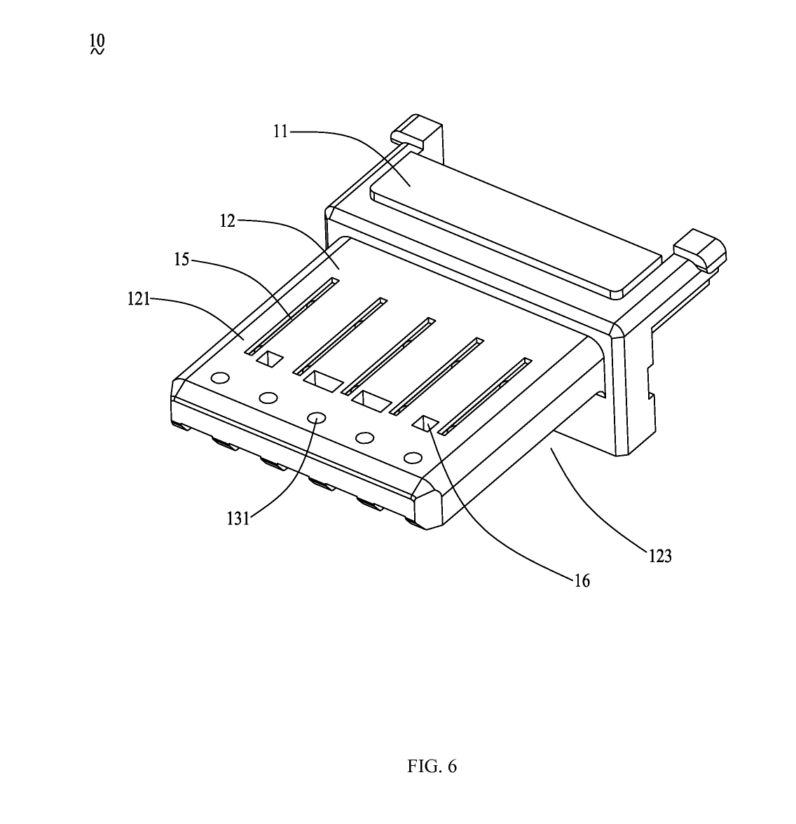

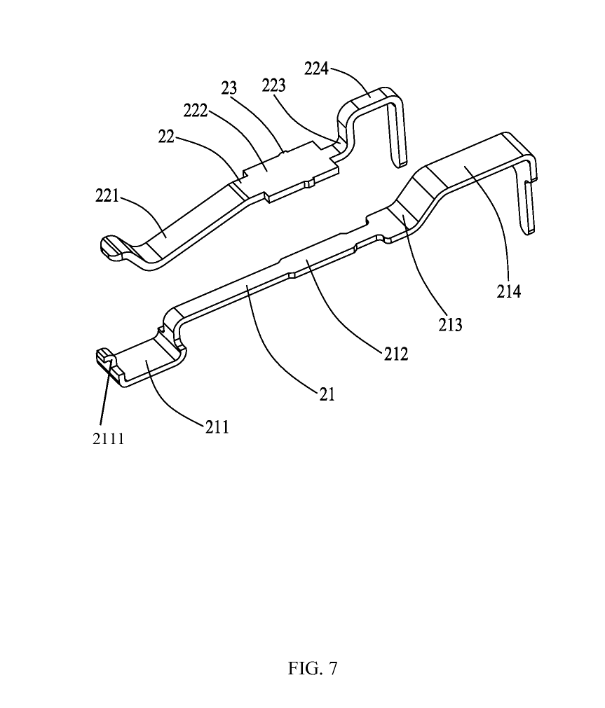

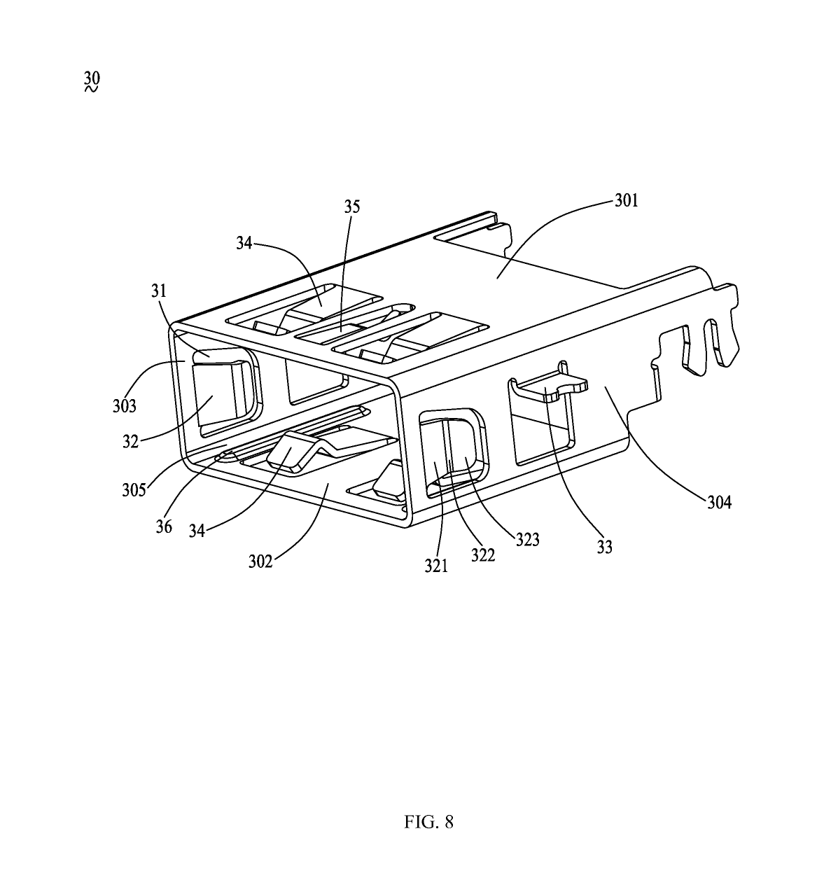

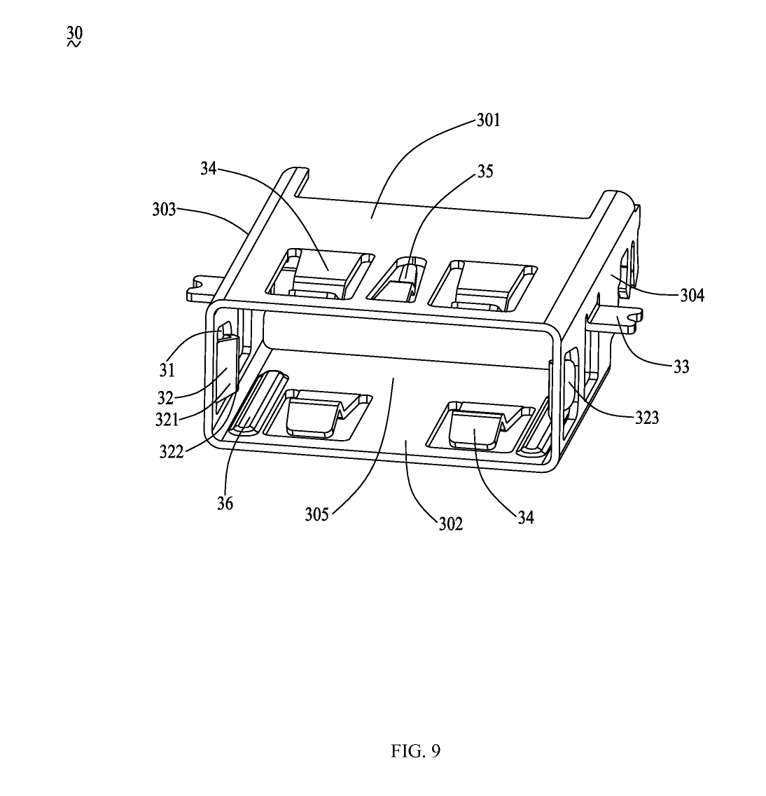

FIG. 6 is a view similar to FIG. 5, but from a different aspect;

FIG. 7 is a perspective view of a group of receptacle contacts shown in FIG. 4;

FIG. 8 is a perspective view of a receptacle shell shown in FIG. 4;

and

FIG. 9 is a view similar to FIG. 8, but from a different aspect.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Reference will be made to the drawing figures to describe the present invention in detail, wherein depicted elements are not necessarily shown to scale and wherein like or similar elements are designated by same or similar reference numeral through the several views and same or similar terminology.

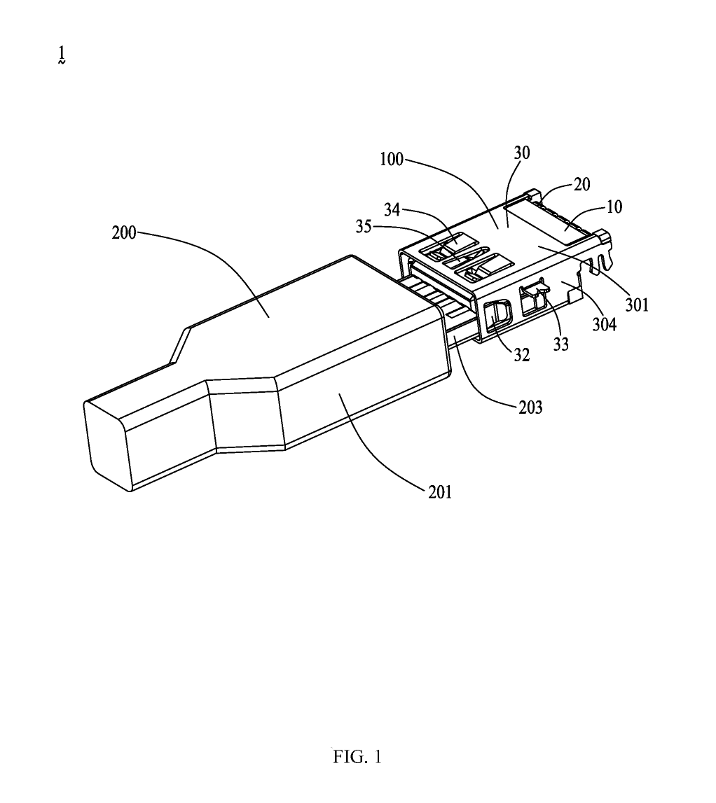

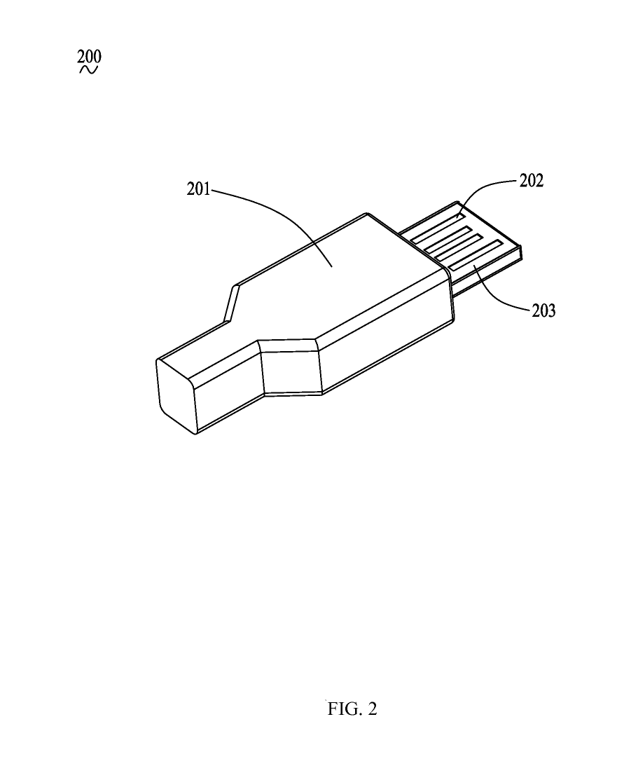

Please refer to FIGS. 1-2, an electrical connector assembly 1 in accordance with the present invention is used to be assembled to Printed Circuit Boards (PCB, not shown). The electrical connector assembly 1 comprises a receptacle connector 100 and a plug connector 200 electrically mating with the receptacle connector 100.

The plug connector 200 comprises a plug housing (not labeled), a plug shell 201 and a plurality of plug contacts 202 accommodated in the plug housing. The plug shell 201 partially encloses the plug housing. The plug connector 200 also comprises an insertion portion 203 which extends outwardly from the plug housing and exposed beyond the plug shell 201. The insertion portion 203 defines a plurality of recesses (not labeled) for accommodating the plug contacts 202. The recesses open toward an upper surface of the insertion portion 203 and communicate with the upper surface, thus the plug contacts 202 are partially exposed to the outside.

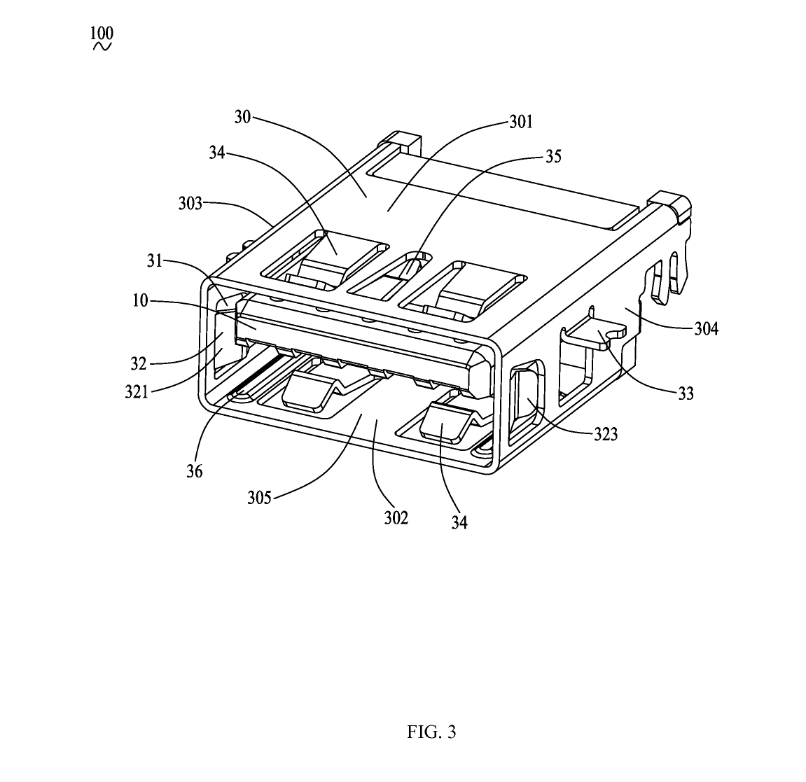

Please refer to FIGS. 3-4, the receptacle connector 100 comprises a receptacle housing 10, a receptacle shell 30 enclosing the receptacle housing 10, and a plurality of receptacle contacts 20 accommodated in the receptacle housing 10.

Please refer to FIGS. 5-6, the receptacle housing 10 comprises a main portion 11 and a tongue portion 12 extending from one end of the main portion 11 along a mating direction between the receptacle connector 100 and the plug connector 200. The tongue portion 12 comprises a top surface 121 and an opposite bottom surface 122. The thickness of the tongue portion 12 is lower than that of the main portion 11, thus a receiving space 123 is defined below the bottom surface 122 of the tongue portion 12. The insertion portion 203 of the plug connector 200 is accommodated in the receiving space 123 to form an electrical connection between the plug contacts 202 and the receptacle contacts 20 in the receiving space 123.

The receptacle housing 10 defines a plurality of receiving slots for receiving the receptacle contacts 20. The receiving slots comprise a plurality of first receiving slots 13 recessed upwardly from a front end of the bottom surface 122 of the tongue portion 12 toward the top surface 121, and a plurality of second receiving slots 14 recessed upwardly from a rear end of the bottom surface 122 of the tongue portion 12 toward the top surface 121. The first and second receiving slots 13, 14 are all opened toward the bottom surface 122 of the tongue portion 12.

The tongue portion 12 defines a plurality of round through holes 131 penetrating therethrough and communicating with respective first receiving slots 13. A plurality of slits 15 are recessed downwardly from the top surface 121 of the tongue portion 12 and communicate with corresponding first receiving slots 13 and located behind the first receiving slots 13.

The second receiving slots 14 are located behind the first receiving slots 13 a certain distance and extend rearward to penetrate through the main portion 11. A plurality of rectangular through recesses 16 are recessed downwardly from the top surface 121 to communicate with front ends of respective second receiving slots 14.

Please refer to FIG. 7 in conjunction with FIGS. 4-6, the receptacle contacts 20 comprise a plurality of first contacts 21 respectively received in the first receiving slots 13, and a plurality of second contacts 22 respectively received in the second receiving slots 14. Both of the first contacts 21 and the second contacts 22 contain at least one grounding contact and a differential pair. In detail, in the preferred embodiment of the present invention, the receptacle contacts 20 comprise five first contacts 21 and four second contacts 22 to make the contact arrangement of the receptacle connector 100 fulfill with the interface standard of USB 3.0.

In the preferred embodiment, the first contacts 21 are insert-molded with the receptacle housing 10, while the second contacts 22 are inserted to be assembled to the receptacle housing 10. Of course, the assembly means of the first contacts 21 and the second contacts 22 also could be other types, here will be omitted. The heat generated by the first contacts 21 in the first receiving slots 13 could be radiated to the outside from the first receiving slots 13, the through holes 131 and the slits 15. The heat generated by the second contacts 22 in the second receiving slots 14 could be radiated to the outside from the second receiving slots 14 and the rectangular through recesses 16.

Each first contact 21 comprises a first contacting portion 211, a first termination portion 214 for being soldered to the PCB, a first intermediate portion 212 extending from one end of the first contacting portion 211 toward the first termination portion 214, and a first connecting portion 213 connecting the first intermediate portion 212 and the first termination portion 214. In the preferred embodiment of the present invention, the first contacting portion 211 is received in the first receiving slots 13 and exposed to the outside for electrically mating with the plug contacts 202.

The second contact 22 comprises a second contacting portion 221, a second termination portion 224 for being soldered to the PCB, a second intermediate portion 222 extending from one end of the second contacting portion 221 toward the second termination portion 224, and a second connecting portion 223 connecting the second intermediate portion 222 and the second termination portion 224. In the preferred embodiment of the present invention, the second contacting portion 221 is received in the second receiving slot 14 and partially exposed to the outside. The second intermediate portion 222 and the second connecting portion 223 are received in the second receiving slot 14 and fully exposed to the outside for convenient connection between the second contact 22 and the plug contact 202.

The first contacting portion 211 is flat with a certain width, and a front free end forms an L-shape securing section 2111 bending vertically therefrom. While, the second contacting portion 221 is curved with a free end thereof exposed beyond the second receiving slot 14. The first connecting portion 213 is inclined to make the height of the first termination portion 214 is higher than that of the second termination portion 224 for being soldered to the PCB conveniently. The second connecting portion 223 is perpendicular to both the second intermediate portion 222 and the second termination portion 224.

The width of the first intermediate portion 212 is less than that of the first contacting portion 211 and the first connecting portion 213. The width of the second intermediate portion 222 is larger than that of the second contacting portion 221 and the second connecting portion 223. A plurality of barbs 23 are formed on opposite sides of the second intermediate portion 222 which interfere with the second receiving slot 14 for retaining the second contact 22 to the receptacle housing 10 reliably.

Please refer to FIGS. 8-9 in conjunction with FIGS. 2, 5-6, the receptacle shell 30 comprises an upper wall 301, a lower wall 302 opposite to the upper wall 301, and opposite left sidewall 303 and right sidewall 304 connecting with both the upper and lower walls 301, 302. A receiving space 305 is circumscribed by the upper and lower walls 301, 302 and the opposite left and right sidewalls 303, 304.

Each of the left and right sidewalls 303, 304 defines an opening 31 with an elastic arm 32 formed in the opening 31 which extends curvedly from a front edge of opening 31 toward a rear edge of the opening 31. The elastic arm 32 comprises an inclined base section 321 extending from the front edge of the opening 31 toward the receiving space 305, a bent section 322 curved away from the receiving space 305 from a free end of the base section 321, and a stretch section 323 bending away from the receiving space 305 from the bent section 322. The width of the elastic arm 32 is reduced gradually from the base section 321 toward the stretch section 323. Thus, when the plug connector 200 mates with the receptacle connector 100, the insertion portion 203 of the plug connector 200 will not fail by the interference of the elastic arms 32.

A step section 33 bends vertically from each of the left and right sidewalls 303, 304 which are tear from the left and right sidewalls 303, 304.

Each of the upper and lower walls 301, 302 is tear to form a pair of spaced first spring arms 34 curved into the receiving space 305. A second spring arm 35 is tear from the upper wall 301 to curve toward the receiving space 305 and located between the pair of first spring arms 34 on the upper wall 301. When the receptacle housing 10 enclosed by the receptacle shell 30 mates with the plug housing, the first and second spring arms 34, 35 could restrict the receptacle housing 10 and the plug housing separating from the receptacle shell 30, thus assuring mating stability.

A pair of protruding ribs 36 extending along the mating direction of the plug connector 200 and the receptacle connector 100 is formed on the lower wall 302 protrudes outwardly toward the upper wall 301. Thus, when the plug connector 200 mates with the receptacle connector 100, the protruding ribs 36 could raise the plug connector 200 a little to assure the contact journal between the plug connector 200 and the receptacle connector 100.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

We claim:

1. An electrical connector assembly, comprising:
a plug connector, comprising:
a plug housing comprising at least an insertion section extending from the plug housing;
a plug shell partially enclosing the plug housing with the insertion section not enclosed; and
a plurality of plug contacts accommodated in the plug housing;
a receptacle connector, comprising:
a plurality of receptacle contacts electrically connecting with the plug contacts to form an electrical connection between the plug connector and the receptacle connector;
a receptacle housing accommodating the receptacle contacts, and defining a receiving space to receive the insertion section of the plug connector to form the electrical connection between the plug contacts and the receptacle contacts in the receiving space;
a receptacle shell comprising a top wall, a bottom wall and a pair of sidewalls connecting with the top wall and the bottom wall; each sidewall defines an opening and forms a trapezoidal-shape elastic arm extending rearward from one edge of the opening and curved toward the receiving space, the bottom wall forms at least one protruding rib protruding toward the top wall and extending along a mating direction between the plug connector and the receptacle connector for assuring the contact journal between the plug connector and the receptacle connector .

2. The electrical connector assembly as claimed in claim 1, wherein the elastic arm comprises an inclined base section extending from the front edge of the opening toward the receiving space, a bent section curved away from the receiving space from a free end of the base section, and a stretch section bending away from the receiving space from the bent section, the width of the elastic arm is gradually decreased from the base section to the stretch section.

3. The electrical connector assembly as claimed in claim 1, wherein each sidewall is tear to form a step section which bends vertically from the sidewall.

4. The electrical connector assembly as claimed in claim 1, wherein the top wall and the bottom wall both are tear to form at least one spring arm which curve toward the receiving space.

5. The electrical connector assembly as claimed in claim 1, wherein the receptacle housing comprises a main portion and a tongue portion extending from the main portion along the mating direction between the receptacle connector and the plug connector, and wherein the receptacle housing defines a plurality of receiving slots to receive the receptacle contacts.

6. The electrical connector assembly as claimed in claim 5, wherein the tongue portion comprises opposite top and bottom surfaces, the receiving slots comprise a plurality of first receiving slots located in the front section of the tongue portion and recessed from the bottom surface toward the top surface, and a plurality of second receiving slots located behind the first receiving slots and extending rearward from a rear section of the tongue portion to penetrate through the main portion, the second receiving slots recessed from the bottom surface of the tongue portion toward the top surface.

7. The electrical connector assembly as claimed in claim 6, wherein the receptacle contacts comprise a plurality of first contacts received in the first receiving slots, and a plurality of second contacts received in the second receiving slots, and each receptacle contact comprises a contacting portion, a termination portion, an intermediate portion extending from one of the contacting portion toward the termination portion, and a connecting portion connecting the intermediate portion and the termination portion.

8. The electrical connector assembly as claimed in claim 7, wherein the contacting portion of the first contact is flat, and wherein the contacting portion of the second contact is curved.

9. The electrical connector assembly as claimed in claim 8, the receptacle contacts comprise five first contacts and four second contacts to make the arrangement of the receptacle contacts fulfill with USB 3.0 interface.

10. A receptacle connector adapted for mating with a plug connector, comprising:
a receptacle housing defining a receiving space;
a plurality of receptacle contacts received in the receptacle housing and partially exposed into the receiving space; and
a receptacle shell comprising a top wall, a bottom wall and a pair of sidewalls connecting with the top wall and the bottom wall; each sidewall defines an opening and forms a trapezoidal-shape elastic arm extending rearward from one edge of the opening and curved toward the receiving space, the bottom wall forms at least one protruding rib protruding toward the top wall and extending along a mating direction between the plug connector and the receptacle connector for assuring the contact journal between the plug connector and the receptacle connector.

11. The receptacle connector as claimed in claim 10, wherein the elastic arm comprises an inclined base section extending from the front edge of the opening toward the receiving space, a bent section curved away from the receiving space from a free end of the base section, and a stretch section bending away from the receiving space from the bent section, the width of the elastic arm is gradually decreased from the base section to the stretch section.

12. The receptacle connector as claimed in claim 10, wherein the receptacle housing comprises a main portion and a tongue portion extending from the main portion along a mating direction between the receptacle connector and the plug connector, and wherein the receptacle housing defines a plurality of receiving slots to receive the receptacle contacts.

13. The receptacle connector as claimed in claim 12, wherein the tongue portion comprises opposite top and bottom surfaces, the receiving slots comprise a plurality of first receiving slots located in the front section of the tongue portion and recessed from the bottom surface toward the top surface, and a plurality of second receiving slots located behind the first receiving slots and extending rearward from a rear section of the tongue portion to penetrate through the main portion, the second receiving slots recessed from the bottom surface of the tongue portion toward the top surface.

14. The receptacle connector as claimed in claim 13, wherein the receptacle contacts comprise a plurality of first contacts received in the first receiving slots, and a plurality of second contacts received in the second receiving slots, and each receptacle contact comprises a contacting portion, a termination portion, an intermediate portion extending from one of the contacting portion toward the termination portion, and a connecting portion connecting the intermediate portion and the termination portion.
